(19) United States
(12) Patent Application Publication
(10) Pub. No.: US 2021/0218879 A1
(43) Pub. Date: Jul. 15, 2021

(54) CONTROL DEVICE, IMAGING APPARATUS, MOBILE OBJECT, CONTROL METHOD AND PROGRAM

(71) Applicant: SZ DJI TECHNOLOGY CO., LTD., Shenzhen (CN)

(72) Inventor: Makoto TAKAMIYA, Tokyo (JP)

(21) Appl. No.: 17/198,233

(22) Filed: Mar. 10, 2021

Related U.S. Application Data
(63) Continuation of application No. PCT/CN2019/108224, filed on Sep. 26, 2019.

(30) Foreign Application Priority Data
Sep. 27, 2018 (JP) 2018-181833

(51) Int. Cl. H04N 5/232; G02B 7/28; G03B 13/36; B64C 39/02

(52) U.S. Cl. CPC H04N 5/23203; G02B 7/28; B64C 39/024; H04N 5/23212; B64C 2201/123; G03B 13/36

(57) ABSTRACT

A control device includes one or more memories storing instructions, and one or more processors configured to, individually or collectively, execute the instructions to according to a positional relationship between an imaging apparatus and a target at a first moment, a speed and a moving direction of the imaging apparatus at the first moment, and a speed and a moving direction of the target at the first moment, derive a distance between the imaging apparatus and the target at a second moment after the first moment, and control a position of a focus lens of the imaging apparatus according to the distance at the second moment.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

This application is a continuation of International Application No. PCT/CN2019/108224, filed Sep. 26, 2019, which claims priority to Japanese Patent Application No. 2018-181833, filed Sep. 27, 2018, the entire contents of both of which are incorporated herein by reference.

### TECHNICAL FIELD

The present disclosure relates to a control device, an imaging apparatus, a mobile object, a control method, and a program.

### BACKGROUND

Patent document 1 discloses a method to control a lens focus driver according to a moving path of an object, a moving speed of the object, an expected position of the object at a certain moment, and a distance to the object, and then to perform focus driving of the lens. Patent document 1: Japanese Patent Application Publication No. H10-142486.

### SUMMARY

In accordance with the disclosure, there is provided a control device including one or more memories storing instructions, and one or more processors configured to, individually or collectively, execute the instructions to according to a positional relationship between an imaging apparatus and a target at a first moment, a speed and a moving direction of the imaging apparatus at the first moment, and a speed and a moving direction of the target at the first moment, derive a distance between the imaging apparatus and the target at a second moment after the first moment, and control a position of a focus lens of the imaging apparatus according to the distance at the second moment.

Also in accordance with the disclosure, there is provided a mobile object configured to an imaging apparatus including a focus lens, an image sensor, and a control device. The control device includes one or more memories storing instructions, and one or more processors configured to, individually or collectively, execute the instructions to according to a positional relationship between an imaging apparatus and a target at a first moment, a speed and a moving direction of the imaging apparatus at the first moment, and a speed and a moving direction of the target at the first moment, derive a distance between the imaging apparatus and the target at a second moment after the first moment, and control a position of a focus lens of the imaging apparatus according to the distance at the second moment.

Also in accordance with the disclosure, there is provided a control method including according to a positional relationship between an imaging apparatus and a target at a first moment, a speed and a moving direction of the imaging apparatus at the first moment, and a speed and a moving direction of the target at the first moment, deriving a distance between the imaging apparatus and the target at a second moment after the first moment, and controlling a position of a focus lens of the imaging apparatus according to the distance at the second moment.

### BRIEF DESCRIPTION OF THE DRAWINGS

FIG. 1 is a diagram showing an example appearance of an unmanned aerial vehicle and a remote control.

FIG. 2 is a schematic functional block diagram of an example unmanned aerial vehicle.

FIG. 3 is a schematic diagram showing an example unmanned aerial vehicle tracking a target.

FIG. 4 is a schematic diagram showing an example coordinate system representing a positional relationship between an unmanned aerial vehicle and a target.

FIG. 5 is a schematic diagram showing an example coordinate system representing another positional relationship between an unmanned aerial vehicle and a target.

FIG. 6 is a schematic diagram showing an example relationship between a focus distance and a position of a focus lens.

FIG. 7 is a schematic diagram explaining a method to determine a focus stability range.

FIG. 8 is a schematic diagram explaining a method to determine a focus stability range.

FIG. 9 is a schematic diagram explaining a method to determine a focus stability range.

FIG. 10 is a schematic flow chart of a program to determine a focus stability range.

FIG. 11 is a schematic diagram of an example hardware.

Reference numerals: UAV 10; UAV main body 20; UAV controller 30; Memory 32; Communication interface 36; Propulsion system 40; GPS receiver 41; IMU 42; Magnetic compass 43; Barometric altimeter 44; Temperature sensor 45; Humidity sensor 46; Gimbal 50; Imaging device 60; Imaging apparatus 100; Imaging unit 102; Imaging controller 110; Derivation circuit 112; Focus controller 114; Determination circuit 116; Image sensor 120; Memory 130; Lens unit 200; Lens 210; Lens driver 212; Position sensor 214; Lens controller 220; Memory 222; Remote control 300; Target 500; Computer 1200; Host controller 1210; CPU 1212; RAM 1214; Input/Output controller 1220; Communication interface 1222; ROM 1230.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The embodiments of the present disclosure will be described with reference to the flow charts and block diagrams. As used herein, the blocks may represent operation processes or components of the device that perform operations. The specific processes and components may be implemented by programmable circuits and/or processors. The circuits may include digital and/or analog hardware circuits, may include integrated circuits (ICs) and/or discrete circuits. The programmable circuits may include reconfigurable hardware circuits. The reconfigurable hardware circuits may include logical operations, such as the logical operation AND, the logical operation OR, the logical operation XOR, the logical operation NAND, and the logical operation NOR, etc. The reconfigurable hardware circuits may also include storage elements, such as flip-flops, registers, field programmable gate arrays (FPGAs), and programmable logic arrays (PLAs), etc.

The operations specified in the flow chart or block diagram may be implemented in the form of program instructions stored on a computer-readable storage medium, which may be sold or used as a standalone product. The computer-readable storage medium may be any suitable device that may store program instructions, which may include an electronic storage medium, a magnetic storage medium, an optic storage medium, an electromagnetic storage medium, and a semiconductor storage medium, etc. The computer-readable storage medium may be, for example, a Floppy® disk, a soft disk, a hard disk, a random-access memory (RAM), a read-only memory (ROM), an erasable programmable read-only memory (EPROM or flash memory), an electrically erasable programmable read-only memory (EEPROM), a static random-access memory (SRAM), a compact disc read-only memory (CD-ROM), a digital versatile disc (DVD), a Blu-ray disc, a memory stick, or an integrated circuit chip, etc.

The computer-readable instructions may include any one of source code or object code described in any combination of one or more programming languages. The source code or the object code includes traditional procedural programming languages. The traditional programming language may be assembly instructions, instruction set architecture (ISA) instructions, machine instructions, machine-related instructions, microcode, firmware instructions, status setting data, an object programming language, e.g., Smalltalk, JAVA (registered trademark), or C++, etc., or “C” programming language. The computer-readable instructions may be provided locally or provided to a processor or a programmable circuit of a general-purpose computer, a special-purpose computer, or another programmable data processing device via a wide area network (WAN), e.g., a local area network (LAN), or the Internet. The processor or the programmable circuit may execute computer-readable instructions to perform the operations specified in the flow chart or block diagram. The processor may be a computer processor, a processing unit, a microprocessor, a digital signal processor, a controller, or a microcontroller, etc.

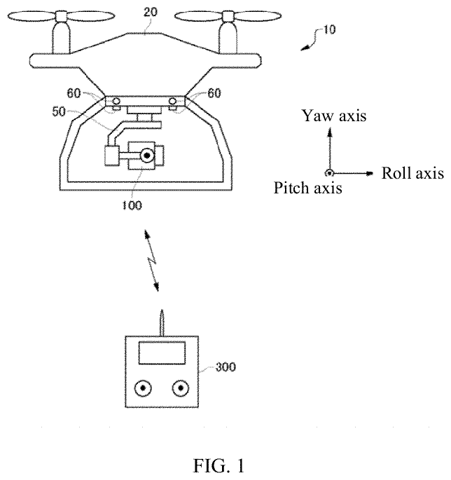

FIG. 1 is a diagram showing an example appearance of an unmanned aerial vehicle (UAV) 10 and a remote control 300. The UAV 10 includes a UAV main body 20, a gimbal 50, a plurality of imaging devices 60, and an imaging apparatus 100. The gimbal 50 and the imaging apparatus 100 are included as an example camera system. The UAV 10 is included as an example mobile object. The mobile object may include a flight object movable in the air, a vehicle movable on the ground, or a ship movable on the water, etc. The flight object movable in the air may include an aircraft such as a UAV, an airship, or a helicopter, etc.

The UAV main body 20 includes a plurality of rotors. The plurality rotors are included as an example propulsion system. The UAV main body 20 enable the UAV 10 to fly by controlling the rotation of the plurality of rotors. The UAV main body 20 uses, for example, four rotors to enable the UAV 10 fly. The number of rotors is not limited to four. In addition, the UAV 10 may also be a fixed-wing aircraft without rotors.

The imaging apparatus 100 includes an imaging camera used to shoot an object included in a desired shooting range. The gimbal 50 may rotatably support the imaging apparatus 100. The gimbal 50 is included as an example supporting mechanism. For example, the gimbal 50 supports the imaging apparatus 100 so that it may be rotated around the pitch axis using an actuator. The gimbal 50 supports the imaging apparatus 100 to enable the imaging apparatus 100 to rotate around a roll axis or a yaw axis using an actuator. The gimbal 50 may change the attitude of the imaging apparatus 100 by rotating the imaging apparatus 100 around at least one of the yaw axis, a pitch axis, or the roll axis.

The plurality of imaging devices 60 include sensing cameras used to shoot surroundings of the UAV 10 to control the flight of the UAV 10. Two of the imaging devices 60 may be mounted at the nose, i.e., at a front, of the UAV 10. In addition, another two of the imaging devices 60 may be mounted at a bottom of the UAV 10. The two imaging devices 60 at the front of the UAV 10 may be paired to function as a stereo camera. The two imaging devices 60 at the bottom of the UAV 10 may also be paired to function as a stereo camera. The imaging device 60 may measure the existence of the object included in a shooting range of the imaging device 60 and a distance to the object. The imaging device 60 is included as an example measurement device for measuring the object existing in a shooting direction of the imaging apparatus 100. The measurement device may include a sensor, for example, an infrared sensor or an ultrasonic sensor, used to measure the object existing in the shooting direction of the imaging apparatus 100. Three-dimensional spatial data around the UAV 10 may be generated according to images taken by the plurality of imaging devices 60. The number of the imaging devices 60 included in the UAV 10 is not limited to four. The UAV 10 includes at least one imaging device 60. The UAV 10 may include at least one imaging device 60 at each of the nose, tail, side, bottom, and top of the UAV 10. A settable viewing angle of the imaging device 60 may be larger than the settable viewing angle of the imaging apparatus 100. The imaging device 60 may have a single focus lens or a fisheye lens.

The remote control 300 communicates with the UAV 10 to operate the UAV 10 remotely. The remote control 300 may communicate with the UAV 10 wirelessly. The remote control 300 sends the UAV 10 instruction information indicating various instructions related to the movement of the UAV 10 such as ascending, descending, accelerating, decelerating, forwarding, retreating, and/or rotating. The instruction information includes, for example, the instruction information for raising a flight altitude of the UAV 10. The instruction information may indicate a desired flight altitude of the UAV 10. The UAV 10 may move to the desired flight altitude indicated by the instruction information received from the remote control 300. The instruction information may include an ascending instruction to instruct the UAV 10 to ascend. The UAV 10 may ascend after receiving the ascending instruction. When the flight altitude of the UAV 10 has reached a maximum flight altitude, even if the ascending instruction is received, the UAV 10 may be restricted from ascending.

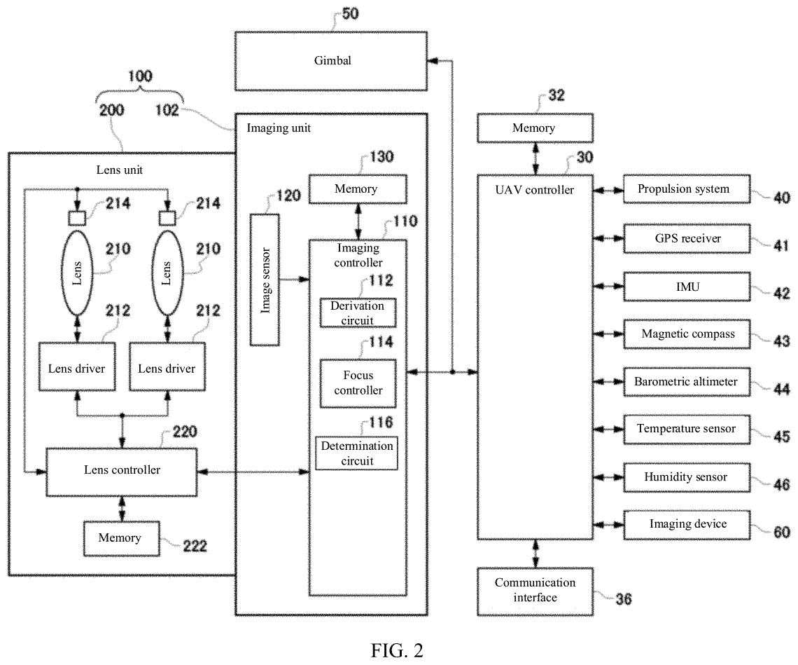

FIG. 2 is a schematic functional block diagram of an example of the unmanned aerial vehicle (UAV) 10. The UAV 10 includes a UAV controller 30, a memory 32, a communication interface 36, a propulsion system 40, a Global Positioning System (GPS) receiver 41, an inertial measurement unit (IMU) 42, a magnetic compass 43, a barometric altimeter 44, a temperature sensor 45, a humidity sensor 46, the gimbal 50, the imaging device 60, and the imaging apparatus 100.

The communication interface 36 communicates with another device such as the remote control 300. The communication interface 36 may receive the instruction information including the various instructions to the UAV controller 30 from the remote control 300. The memory 32 stores a program for the UAV controller 30 to control the propulsion system 40, the GPS receiver 41, the IMU 42, the magnetic compass 43, the barometric altimeter 44, the temperature sensor 45, the humidity sensor 46, the gimbal 50, the imaging device 60, and the imaging apparatus 100, etc. The memory 32 may be the computer-readable storage medium and may include at least one of an SRAM, a dynamic random-access memory (DRAM), an EPROM, an EEPROM, or a flash memory such as a USB memory. The memory 32 may be arranged inside the UAV main body 20. The memory 32 may be detachably mounted at the UAV main body 20.

The UAV controller 30 controls flight and shooting of the UAV 10 according to the program stored in the memory 32. The UAV controller 30 may include a microprocessor, e.g., a central processing unit (CPU) or a microprocessor unit (MPU), and/or a microcontroller, e.g., a microcontroller unit (MCU), etc. The UAV controller 30 controls the flight and shooting of the UAV 10 according to the instructions received from the remote control 300 via the communication interface 36. The propulsion system 40 propels the UAV 10. The propulsion system 40 includes the plurality of rotors and a plurality of drive motors used to drive the plurality of rotors to rotate. The propulsion system 40 rotates the plurality of rotors via the plurality of drive motors according to the instruction from the UAV controller 30 to enable the UAV 10 to fly.

The GPS receiver 41 receives a plurality of signals indicating transmission timings from a plurality of GPS satellites. The GPS receiver 41 calculates a position (a latitude and a longitude) of the GPS receiver 41, that is, the position (the latitude and the longitude) of the UAV 10, according to the signals received. The IMU 42 detects the attitude of the UAV 10. The IMU 42 detects accelerations of the UAV 10 in an axis direction of front and rear, an axis direction of left and right, and an axis direction of up and down, and angular velocities around the pitch axis, the roll axis, and the yaw axis as the attitude of the UAV 10. The magnetic compass 43 detects the orientation of the nose of the UAV 10. The barometric altimeter 44 detects the flight altitude of the UAV 10. The barometric altimeter 44 detects the air pressure around the UAV 10 and converts the detected air pressure into an altitude to detect the flight altitude. The temperature sensor 45 detects the temperature around the UAV 10. The humidity sensor 46 detects the humidity around the UAV 10.

The imaging apparatus 100 includes an imaging unit 102 and a lens unit 200. The lens unit 200 is included as an example lens device. The imaging unit 102 includes an image sensor 120, an imaging controller 110, and a memory 130. The image sensor 120 may include a charge coupled device (CCD) or a complementary metal oxide semiconductor (CMOS). The image sensor 120 captures optical images formed through a plurality of lenses 210 and outputs captured image data to the imaging controller 110. The imaging controller 110 may include a microprocessor, e.g., a CPU or an MPU, and/or a microcontroller, e.g., an MCU, etc. The imaging controller 110 may control the imaging apparatus 100 according to the instructions received from the UAV controller 30. The memory 130 may be the computer-readable storage medium and may include the at least one of an SRAM, a DRAM, an EPROM, an EEPROM, or a flash memory such as a USB memory. The memory 130 stores a program for the imaging controller 110 to control the image sensor 120, etc. The memory 130 may be arranged inside a housing of the imaging apparatus 100. The memory 130 may be detachably mounted at the housing of the imaging apparatus 100.

The lens unit 200 includes the plurality of lenses 210, a plurality of lens driver 212, and a lens controller 220. The plurality of lenses 210 may be used as zoom lenses, variable focal length lenses, and focus lenses. At least a part or all of the plurality of lenses 210 are movably arranged along an optical axis. The lens unit 200 may be an interchangeable lens detachable mounted to the imaging unit 102. The lens driver 212 enables the at least a part or all of the plurality of lenses 210 to move along the optical axis via a mechanism member such as a cam ring. The lens driver 212 may include the actuator. The actuator may include a step motor. The lens controller 220 drives the lens driver 212 to enable one or more lenses 210 to move along the optical axis via the mechanism member according to a lens control instruction from the imaging unit 102. The lens control instruction is, for example, a zoom control instruction or a focus control instruction.

The lens unit 200 also includes the memory 222 and a position sensor 214. The lens controller 220 controls the one or more lenses 210 to move along the optical axis via the lens driver 212 according to the lens controller instruction from the imaging unit 102. The at least a part or all of the plurality of lenses 210 moves along the optical axis. The lens controller 220 performs at least one of zoom operation or focus operation by enabling at least one of the plurality lenses 210 to move along the optical axis. The position sensor 214 detects the position of the lens 210. The position sensor 214 may detect a current zoom position or a current focus position.

The lens driver 212 may include a shake correction mechanism. The lens controller 220 may enable the lens 210 to move along the optical axis or perpendicular to the optical axis via the shake correction mechanism to perform shake correction. The lens driver 212 may drive the shake correction mechanism by the step motor to perform the shake correction. In addition, the shake correction mechanism may be driven by the step motor to enable the image sensor 120 to move along the optical axis or perpendicular to the optical axis to perform the shake correction.

The memory 222 stores control values for the plurality of lenses 210 to be moved via the lens driver 212. The memory 222 may include the at least one of an SRAM, a DRAM, an EPROM, an EEPROM, or a flash memory such as a USB memory.

For the above-described UAV 10, the distance between a target, such as a moving object, and the imaging apparatus 100 is predicted and the target is tracked. The imaging apparatus 100 controls the position of the focus lens according to a predicted distance to focus on the target.

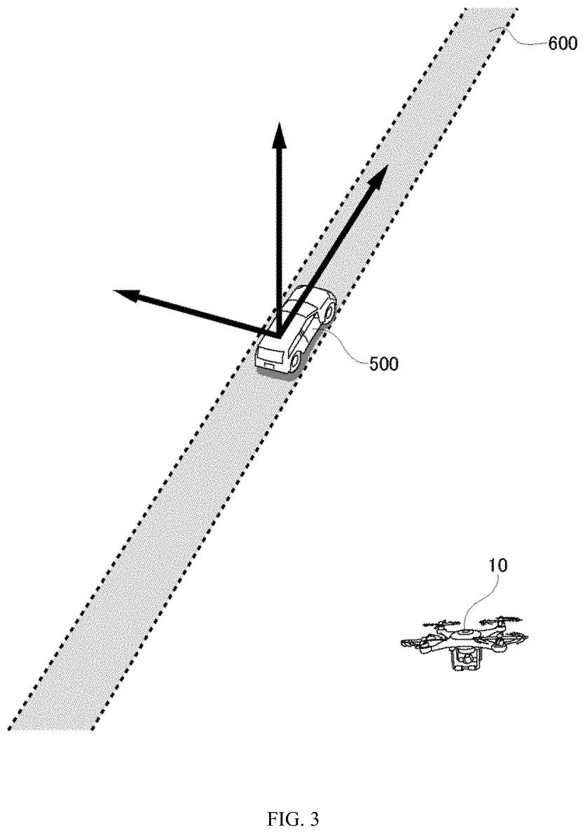

FIG. 3 is a schematic diagram showing an example unmanned aerial vehicle tracking a target. As shown in FIG. 3, in an example embodiment, the UAV 10 tracks the vehicle traveling on a road 600 as a target 500 and the imaging apparatus 100 shoots the target 500 simultaneously.

The imaging controller 110 includes a derivation circuit 112 and a focus controller 114. Based on a positional relationship between the imaging apparatus 100 and the target 500 being shot by the imaging apparatus 100 at a first moment, a speed and moving direction of the imaging apparatus 100 at the first moment, and a speed and moving direction of the target 500 at the first moment, the derivation circuit 112 derives the distance from the imaging apparatus 100 to the target 500 at a second moment after the first moment. The derivation circuit 112 predictively derives the distance from the imaging apparatus 100 to the target 500 at a moment after a predetermined period (for example, 5 seconds later) of the current moment, according to the positional relationship between the imaging apparatus 100 and the target 500 being shot by the imaging apparatus 100 at the current moment, the speed and moving direction of the imaging apparatus 100 at the current moment, and the speed and moving direction of the target 500 at the current moment. The focus controller 114 controls the position of the focus lens of the imaging apparatus 100 according to the distance at the second moment. The focus controller 114 controls the position of the focus lens at the second moment to cause a focus to be at the distance derived by the derivation circuit 112.

The derivation circuit 112 determines the distance between the imaging apparatus 100 and the target 500 at the first moment and a direction from the imaging apparatus 100 to the target 500 at the first moment as the positional relationship. The derivation circuit 112 may determine the distance between the imaging apparatus 100 and the target 500 at the first moment according to a result of contrast autofocus (contrast AF) or phase detection AF performed by the focus controller 114 based on a plurality of images shot by the imaging apparatus 100. The derivation circuit 112 may determine the distance from the imaging apparatus 100 to the target 500 according to the result of the distance measured by a distance measurement sensor included in the imaging apparatus 100. The derivation circuit 112 may determine the direction from the imaging apparatus 100 to the target 500 at the first moment according to position information of the UAV 10 determined based on the plurality of signals received by the GPS receiver 41, the direction of the gimbal 50 relative to the UAV 10 determined based on a drive instruction of the gimbal 50, and the image shot by the imaging apparatus 100.

The derivation circuit 112 determines the position information of the UAV 10 from the GPS receiver 41, altitude information from the barometric altimeter 44, and the position information and altitude information of the target 500 from the GPS receiver as the positional relationship.

The derivation circuit 112 may determine the position of the imaging apparatus 100 in a preset three-dimensional coordinate system and the position of the target 500 in the preset three-dimensional coordinate system at the first moment according to the position relationship. The derivation circuit 112 may be determine the position of the imaging apparatus 100 in a coordinate system and the position of the target 500 in the coordinate system at the second moment according to the position of the imaging apparatus 100 in the coordinate system at the first moment, the position of the target 500 in the coordinate system, the speed and moving direction of the imaging apparatus 100 at the first moment, and the speed and moving direction of the target 500 at the first moment. The derivation circuit 112 may derive the distance at the second moment according to the position of the imaging apparatus 100 at the second moment and the position of the target at the second moment.

The derivation circuit 112 may set the coordinate system according to the moving direction of the target 500 at the first moment. The derivation circuit 112 may set a first axis of the coordinate system along the moving direction of the target 500. The derivation circuit 112 may set the position of the target 500 at the first moment as an origin of the coordinate system.

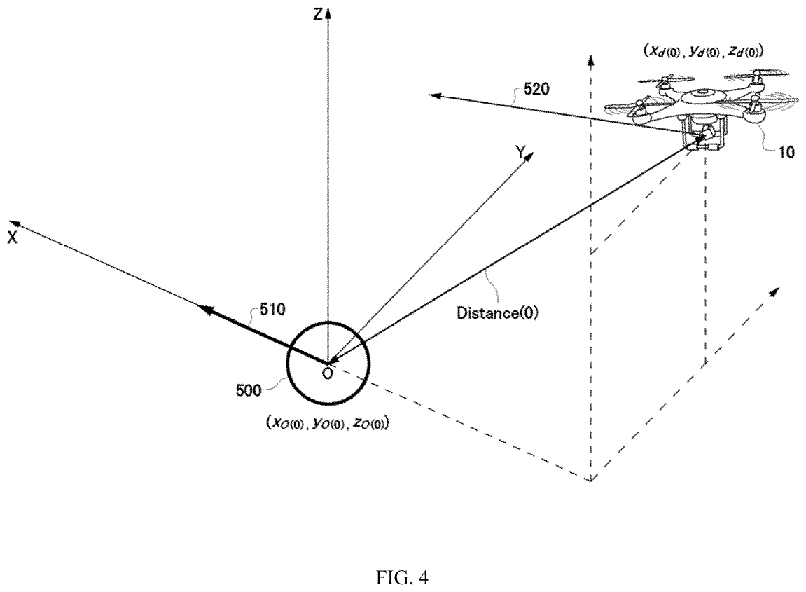

FIG. 4 is a schematic diagram showing an example coordinate system representing a positional relationship between an unmanned aerial vehicle and a target. As shown in FIG. 4, in an example embodiment, the derivation circuit 112 may set the X axis of the coordinate system along the direction of a moving vector 510 of the target 500. The derivation circuit 112 may determine the moving vector 510 of the target 500 according to an optical flow determined from the plurality of images shot by the imaging apparatus 100. The derivation circuit 112 may determine the movement vector 510 of the target 500 according to the optical flow determined from a plurality of images captured by the imaging apparatus 100. The derivation circuit 112 may set a moving vector 520 of the UAV 10 in the coordinate system. The derivation circuit 112 may determine the moving vector 520 of the UAV 10 according to the instruction of the UAV 10 sent by the remote control 300. The derivation circuit 112 may determine the moving vector 510 of the target 500 according to the optical flow determined from the plurality of images shot by the imaging apparatus 100 and the instruction of the UAV 10 sent by the remote control 300.

The derivation circuit 112 may determine Distance (0), representing the distance between the imaging apparatus 100 and the target 500 at the first moment, using formula (1) according to the coordinate point (xₒ₍₀₎, yₒ₍₀₎, zₒ₍₀₎) of the target 500 in the coordinate system and the coordinate point (x_{d(0)}, y_{d(0)}, z_{d(0)}) of the UAV 10 in the coordinate system.

Distance(0)={square root over ({(xₒ₍₀₎−x_{d(0)})²+yₒ₍₀₎−y_{d(0)})²÷(zₒ₍₀₎−z_{d(0)})²})} (1)

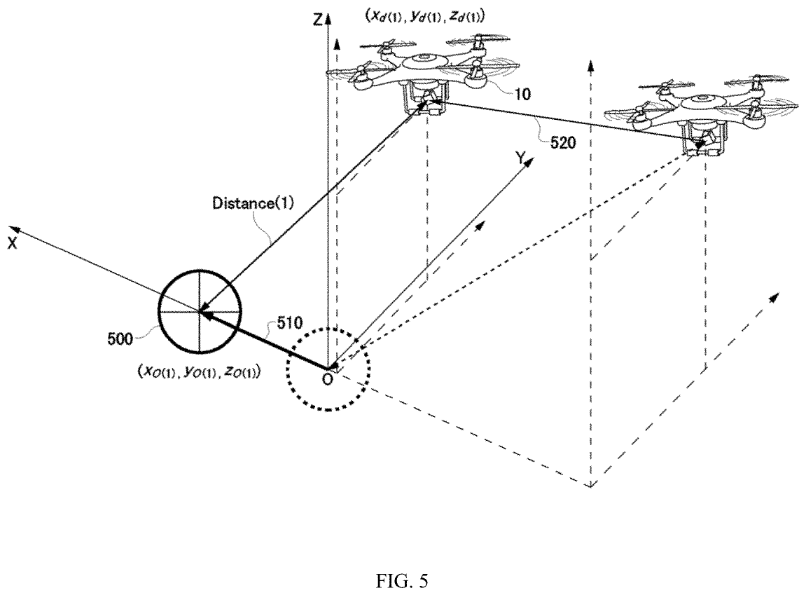

FIG. 5 is a schematic diagram showing an example coordinate system representing another positional relationship between an unmanned aerial vehicle and a target. As shown in FIG. 5, in an example embodiment, the derivation circuit 112 may determine the coordinate point (x_{d(1)}, y_{d(1)}, z_{d(1)}) of the target 500 in the coordinate system at the second moment and the coordinate point (x_{d(1)}, y_{d(1)}, z_{d(1)}) of the UAV 10 in the coordinate system at the second moment according to the coordinate point (xₒ₍₀₎, yₒ₍₀₎, zₒ₍₀₎) of the target 500 in the coordinate system at the first moment, the coordinate point (x_{d(0)}, y_{d(0)}, z_{d(0)}) of the UAV 10 in the coordinate system at the first moment, the moving vector 510 of the target 500 at the first moment, and the moving vector 520 of the UAV 10 at the first moment. In addition, the derivation circuit 112 may determine Distance (1), representing the distance between the imaging apparatus 100 and the target 500 at the second moment, using formula (2) according to the coordinate point (xₒ₍₁₎, yₒ₍₁₎, zₒ₍₁₎) of the target 500 in the coordinate system at the second moment and the coordinate point (x_{d(1)}, y_{d(1)}, z_{d(1)}) of the UAV 10 in the coordinate system at the second moment.

Distance(1)={square root over ({(xₒ₍₁₎−x_{d(1)})²+yₒ₍₁₎−y_{d(1)})²÷(zₒ₍₁₎−z_{d(1)})²})} (2)

The derivation circuit 112 may periodically determine the moving direction of the target 500 and periodically update the coordinate system according to the moving direction of the target 500. The derivation circuit 112 updates the coordinate point of the target 500 and the coordinate point of the UAV 10 in the coordinate system while updating the coordinate system.

When the target 500 is determined to be a vehicle according to the image shot by the imaging apparatus 100, and the derivation circuit 112 assumes that the target 500 does not move along the direction of a Z axis of the coordinate system perpendicular to the vehicle, the derivation circuit may determine the position of the imaging apparatus 100 and the position of the target 500 in the coordinate system at the second moment. The direction perpendicular to the vehicle may be the direction perpendicular to the moving direction of the vehicle. When the target 500 is determined to be a vehicle according to the image shot by the imaging apparatus 100, and the derivation circuit 112 assumes that the target 500 does not move along the direction of a Z axis of the coordinate system perpendicular to the vehicle, the derivation circuit determines the coordinate point (xₒ₍₁₎, yₒ₍₁₎, zₒ₍₁₎) of the target 500 in the coordinate system at the second moment and the coordinate point (x_{d(1)}, y_{d(1)}, z_{d(1)}) of the UAV 10 in the coordinate system at the second moment.

When the target 500 is determined to be a vehicle traveling on a straight road according to the image shot by the imaging apparatus 100, and the derivation circuit 112 assumes that the target 500 does not move along the direction of the Z axis of the coordinate system perpendicular to the vehicle and along the direction of the Y axis of the coordinate system perpendicular to the X axis and the Z axis, the derivation circuit 112 may determine the position of the imaging apparatus 100 and the position of the target 500 in the coordinate system at the second moment.

The derivation circuit 112 may determine that the target 500 is a vehicle by using pattern recognition on the image shot by the imaging apparatus 100. The derivation circuit 112 may determine that the target 500 is a vehicle according to a target type preset by a user. The derivation circuit 112 may determine whether the vehicle travels on the straight road by using the pattern recognition on the image shot by the imaging apparatus 100. The derivation circuit 112 may determine whether the vehicle travels on the straight road according to GPS information and map information of the vehicle obtained through the communication interface 36.

The derivation circuit 112 may determine the moving direction of the target 500 by using pattern recognition on the image shot by the imaging apparatus 100. The derivation circuit 112 may determine the moving direction of the target 500 according to the result of a main object detection performed by the focus controller 114. The derivation circuit 112 may determine the moving direction of the target 500 according to roll information of the imaging apparatus 100. The derivation circuit 112 may determine the roll information of the imaging apparatus 100 according to the drive instruction of the gimbal 50 and then determine the moving direction of the target 500. The derivation circuit 112 may determine the moving direction of the target 500 according to the distance to the target 500 measured by the distance measurement sensor or the stereo camera, and then determine the moving direction of the UAV 10. The derivation circuit 112 may determine the moving direction of the target 500 according to the distance to the target 500 determined by the contrast AF or the phase detection AF of the focus control 114 and the moving direction of the UAV 10.

As described above, according to the UAV 10 consistent with the embodiments of the present disclosure, the UAV 10 predicts the distance of the target 500 as the mobile object during the flight of the UAV 10 and controls the position of the focus lens according to the predicted distance simultaneously. Thus, the imaging apparatus 100 carried by the UAV 10 may maintain a focus state on the target 500.

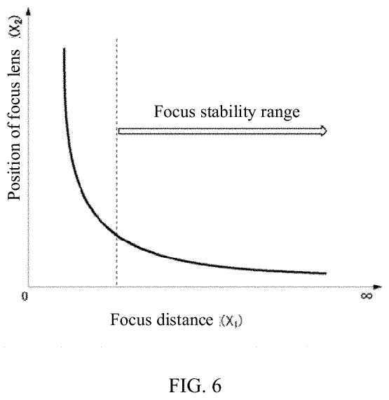

FIG. 6 is a schematic diagram showing an example relationship between a focus distance and a focus lens. The focus distance indicates the distance to the object that may obtain a predetermined focus state relative to the position of the focus lens. The focus distance indicates the distance to the object whose contrast value is greater than or equal to a predetermined threshold relative to the position of the focus lens. As shown in FIG. 6, when the distance from the imaging apparatus 100 to the object is relatively short, a ratio of a position change of the focus lens to a distance change is relatively large. That is, when the distance between the imaging apparatus 100 and the target 500 is relatively short, the ratio of the position change of the focus lens to the distance change is relatively large. Therefore, when the distance between the imaging apparatus 100 and the target 500 is relatively short, it may be difficult to move the focus lens in time, and the imaging apparatus 100 may not be able to track the target 500 while maintaining an appropriate focus state.

Therefore, the UAV controller 30 may control the movement of the UAV 10 to cause the distance from the imaging apparatus 100 to the target 500 to fall within a focus stability range. The focus stability range is a preset distance range where the position change of the focus lens at each unit change of the focus distance is less than or equal to a predetermined threshold. The focus stability range may be determined through an experiment or a simulation in advance.

The focus stability range depends on optical characteristics of the focus lens. That is, the focus stability range depends on a type of lens unit 200. If the lens unit 200 attached to the imaging unit 102 is the interchangeable lens, the focus stability range varies according to the type of interchangeable lens. Therefore, if the lens unit 200 attached to the imaging unit 102 is the interchangeable lens, then before the UAV 10 starts flying or before the target object is tracked, the focus lens may be driven to determine the relationship between the position of the focus lens and the focus distance, and the focus stability range relative to the interchangeable lens attached may be set.

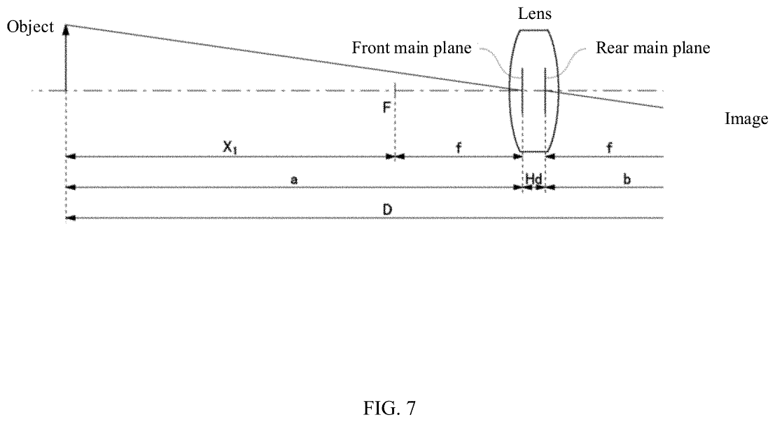

FIG. 7 is a schematic diagram explaining a method to determine a focus stability range. In FIG. 7, f represents the focal length, X₁ represents the distance from a focal plane F to the object, a represents the distance from a front main plane to the object, X₂ represents an amount of defocus, b represents the distance from a rear main plane to the image formed at the image sensor 120, Hd represents the distance between the front main plane and the rear main plane, and D represents the distance from the object to the imaging surface of the image sensor 120, that is, the object distance.

According to Newton's lens formula, X₁·X₂=f². When X₁=D−2·f−Hd, X₂=f²/X₁=f²/(D−2·f−Hd). The amount of defocus is determined according to this formula.

The imaging controller 110 includes a determination circuit 116 used to determine the focus stability range. The determination circuit 116 changes the position of the focus lens to obtain a plurality of focus distances (reference focus distances) to the object in a focused state and a plurality of corresponding positions (reference lens positions) of the focus lens, to derive a relationship between the position of the focus lens and the focus distance according to the plurality of focus distances and the plurality of positions of the focus lens, and to determine the focus stability range as the predetermined distance range according to the relationship.

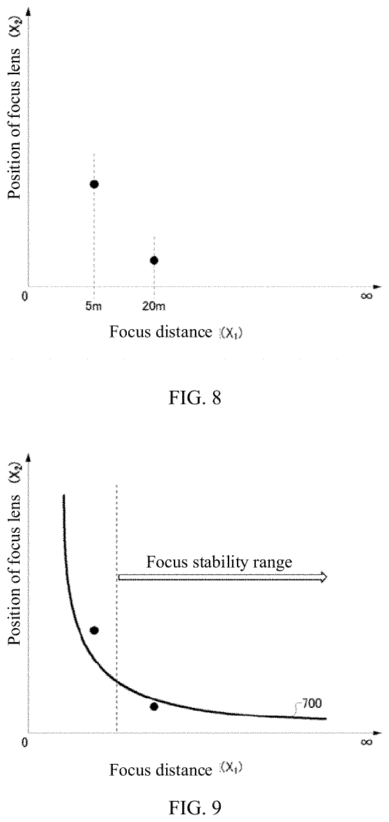

The determination circuit 116 may determine the position of the focus lens corresponding to each of the plurality of the focus distances, and determine a curve showing the relationship between the position of the focus lens and the focus distance according to the result. For example, as shown in FIG. 8, the determination circuit 116 determines the positions of the focus lens at the focus distances of 5 m and 20 m, respectively. The determination circuit 116 may determine the curve 700 showing the relationship between the position of the focus lens and the focus distance as shown in FIG. 9 from these two points, and determine the focus stability range where the position change of the focus lens at each unit of the focus distance is less than or equal to the predetermined threshold through the curve 700.

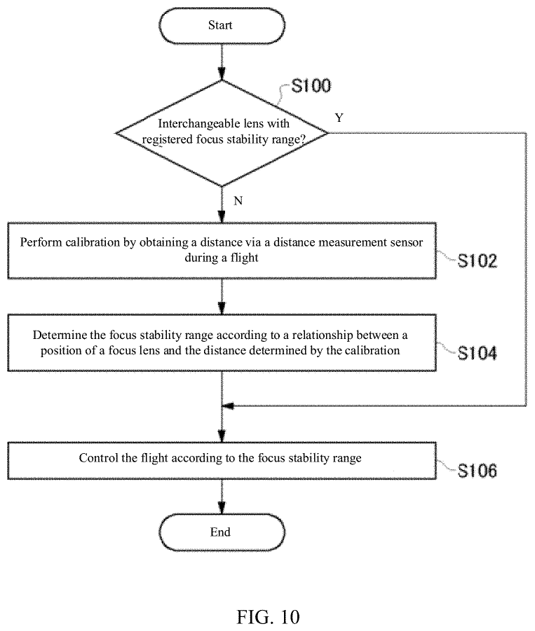

FIG. 10 is a schematic flow chart of a program to determine a focus stability range. As shown in FIG. 10, when tracking the moving object, the determination circuit 116 determines whether the lens unit 200 attached to the imaging unit 102 is an interchangeable lens with the focus stability range registered (S100). If no interchangeable lens with registered focus stability range is attached to the imaging unit 102, the determination circuit 116 performs calibration by obtaining the distance to the object through the distance measurement sensor during the flight of the UAV 10 and determines the position of the focus lens corresponding to the distance (S102). The determination circuit 116 determines the focus stability range according to the relationship between the position of the focus lens and the focus distance determined by the calibration (S104). The determination circuit 116 notifies the UAV controller 30 of the registered or determined focus stability range. The UAV controller 30 controls the flight of the UAV 10 to cause the distance to the object to fall within the focus stability range (S106).

According to the embodiments of the present disclosure, in addition to the target 500, even if the imaging apparatus 100 moves, the state of focusing on the target may be maintained. In addition, the flight of the UAV 10 is controlled to cause the distance from the imaging apparatus 100 to the target 500 to fall within the focus stability range according to the relationship between the position of the focus lens and the focus distance, thereby preventing the imaging apparatus 100 from being unable to track the target 500 while maintaining the appropriate focus state due to the inability to move the focus lens in time.

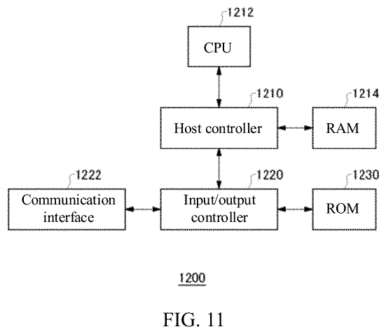

FIG. 11 is a schematic diagram of an example computer 1200 which may perform part or all of technical solutions consistent with the present disclosure. The program installed on the computer 1200 can enable the computer 1200 to function as operations associated with the device consistent with the embodiments of the present disclosure or one or more “components” of the device. Alternatively, the program may enable the computer 1200 to perform the operation or the one or more “components.” The program enables the computer 1200 to execute the process or stages of the process consistent with the embodiments of the present disclosure. The program may be executed by a CPU 1212 to make the computer 1200 execute specified operations associated with some or all blocks in the flow chart and block diagram described in this specification.

In an example embodiment, the computer 1200 includes the CPU 1212 and a RAM 1214, which are connected to each other through a host controller 1210. The computer 1200 also includes a communication interface 1222 and an input/output unit, which are connected to the host controller 1210 through an input/output controller 1220. The computer 1200 also includes a ROM 1230. The CPU 1212 operates according to the programs stored in the ROM 1230 and the RAM 1214 to control each unit.

The communication interface 1222 communicates with another electronic device via a network. A hard disk drive may store programs and data used by the CPU 1212 of the computer 1200. The ROM 1230 therein stores a boot program executed by the computer 1200 during operation, and/or the program for hardware of the computer 1200. The program is provided via the network or the computer-readable storage medium, such as a CD-ROM, a USB memory, or an IC chip. The program is stored in the RAM 1214 or the ROM 1230, which are also examples of the computer-readable storage medium, and is executed by the CPU 1212. The information processing recorded in the programs is read by the computer 1200 to cause cooperation between the programs and various types of hardware resources described above. The apparatus or method may include operations or processing to implement information according to using of the computer 1200.

For example, when communication is performed between the computer 1200 and an external device, the CPU 1212 may execute a communication program loaded in the RAM 1214 and instruct the communication interface 1222 to perform communication processing according to the processing described in the communication program. The communication interface 1222 reads the transmission data stored in a transmission buffer provided in the storage medium such as the RAM 1214 or the USB memory under the control of the CPU 1212, and transmits read transmission data to the network or writes received data from the network into a reception buffer provided in the storage medium.

In addition, the CPU 1212 may enable the RAM 1214 to read files or all or required part of database stored in an external storage medium such as the USB memory, and perform various types of processing on data in the RAM 1214. Then, the CPU 1212 may write processed data back to the external storage medium.

Various types of information such as various types of programs, data, tables, and databases may be stored in the storage medium and be performed information processing on. For the data read from the RAM 1214, the CPU 1212 may perform various types of operations, information processing, conditional judgment, conditional transfer, unconditional transfer, and information retrieval/replacement specified by the instruction sequence of the program as described in various places in the disclosure, and write the result back to the RAM 1214. In addition, the CPU 1212 may retrieve information from files, databases, etc., in the storage medium. For example, when a plurality of entries of a first attribute that are associated with attribute values of a second attribute are stored in the recording medium, the CPU 1212 may retrieve the attribute value of a specified first attribute from the plurality of entries and read the attribute value of the second attribute stored in the entry to obtain the attribute value of the second attribute associated with the first attribute satisfying the predetermined condition.

The above-described programs or software modules may be stored in the computer 1200 or in the computer-readable storage medium near the computer 1200. In addition, the storage medium such as the hard disk or the RAM provided in a server system connected to a dedicated communication network or the Internet may be used as a computer-readable storage medium to cause the program to be provided to the computer 1200 via the network.

An execution order of the actions, sequences, processes, and stages in the devices, systems, programs, and methods consistent with claims, specification, and drawings, as long as there is no special indication “in front of,” “before,” etc., and as long as an output of previous processing is not used in the subsequent processing, may be implemented in any order. Regarding the operating procedures in the claims, the specification, and the drawings, terms “first,” “next,” etc. used in the descriptions for convenience, but do not limit an implementation order.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A control device comprising:
one or more memories storing instructions; and
one or more processors configured to, individually or collectively, execute the instructions to:
according to a positional relationship between an imaging apparatus and a target at a first moment, a speed and a moving direction of the imaging apparatus at the first moment, and a speed and a moving direction of the target at the first moment, derive a distance between the imaging apparatus and the target at a second moment after the first moment; and
control a position of a focus lens of the imaging apparatus according to the distance at the second moment.

2. The control device of claim 1, wherein the one or more processors are further configured to execute the instructions to determine a distance between the imaging apparatus and the target and a direction from the imaging apparatus to the target at the first moment as the positional relationship at the first moment.

3. The control device of claim 1, wherein the one or more processors are further configured to execute the instructions to:
determine a position of the imaging apparatus and a position of the target in a three-dimensional coordinate system at the first moment according to the positional relationship;
determine a position of the imaging apparatus and a position of the target in the three-dimensional coordinate system at the second moment according to the position of the imaging apparatus and the position of the target in the three-dimensional coordinate system at the first moment, the speed and the moving direction of the imaging apparatus at the first moment, and the speed and the moving direction of the target at the first moment; and
derive the distance at the second moment according to the position of the imaging apparatus and the position of the target at the second moment.

4. The control device of claim 3, wherein the one or more processors are further configured to execute the instructions to set the three-dimensional coordinate system according to the moving direction of the target at the first moment.

5. The control device of claim 4, wherein the one or more processors are further configured to execute the instructions to set the position of the target at the first moment as an origin of the three-dimensional coordinate system.

6. The control device of claim 4, wherein the one or more processors are further configured to execute the instructions to set an axis of the three-dimensional coordinate system to be along the moving direction of the target.

7. The control device of claim 6, wherein:
the axis is a first axis of the three-dimensional coordinate system; and
the one or more processors are further configured to execute the instructions to:
determine that the target is a vehicle according to an image shot by the imaging apparatus; and
determine that the target does not move along a second axis of the three-dimensional coordinate system perpendicular to the moving direction of the target.

8. The control device of claim 6, wherein:
the axis is a first axis of the three-dimensional coordinate system; and
the one or more processors are further configured to execute the instructions to:
determine that the target is a vehicle traveling on a straight road according to an image shot by the imaging apparatus; and
determine that the target does not move along a second axis of the three-dimensional coordinate system perpendicular to the moving direction of the target, and does not move along a third axis of the three-dimensional coordinate system perpendicular to the moving direction of the target and the second axis.

9. An imaging apparatus comprising:
a focus lens;
an image sensor; and
the control device of claim 1.

10. A mobile object comprising:
an imaging apparatus including:
a focus lens;
an image sensor; and
a control device including:
one or more memories storing instructions; and
one or more processors configured to, individually or collectively, execute the instructions to:
according to a positional relationship between an imaging apparatus and a target at a first moment, a speed and a moving direction of the imaging apparatus at the first moment, and a speed and a moving direction of the target at the first moment, derive a distance between the imaging apparatus and the target at a second moment after the first moment; and
control a position of a focus lens of the imaging apparatus according to the distance at the second moment.

11. The mobile object of claim 10, wherein the one or more processors are further configured to execute the instructions to control movement of the mobile object to cause the distance between the imaging apparatus and the target to fall within a predetermined distance range that allows a position change of the focus lens per unit distance change of a focus distance to the target in a focused state to be less than or equal to a predetermined threshold.

12. The mobile object of claim 11, wherein the one or more processors are further configured to execute the instructions to:
change the position of the focus lens to obtain a plurality of reference focus distances to the target in the focused state and a plurality of corresponding reference lens positions of the focus lens;
derive a relationship between the position of the focus lens and the focus distance according to the plurality of reference focus distances and the plurality of reference lens positions; and
determine the predetermined distance range according to the relationship.

13. A control method comprising:
according to a positional relationship between an imaging apparatus and a target at a first moment, a speed and a moving direction of the imaging apparatus at the first moment, and a speed and a moving direction of the target at the first moment, deriving a distance between the imaging apparatus and the target at a second moment after the first moment; and
controlling a position of a focus lens of the imaging apparatus according to the distance at the second moment.

14. The control method of claim 13, further comprising:
determining a distance between the imaging apparatus and the target and a direction from the imaging apparatus to the target at the first moment as the positional relationship at the first moment.

15. The control method of claim 13, wherein deriving the distance between the imaging apparatus and the target at the second moment includes:
determining a position of the imaging apparatus and a position of the target in a three-dimensional coordinate system at the first moment according to the positional relationship;
determining a position of the imaging apparatus and a position of the target in the three-dimensional coordinate system at the second moment according to the position of the imaging apparatus and the position of the target in the three-dimensional coordinate system at the first moment, the speed and the moving direction of the imaging apparatus at the first moment, and the speed and the moving direction of the target at the first moment; and
deriving the distance at the second moment according to the position of the imaging apparatus and the position of the target at the second moment.

16. The control method of claim 15, further comprising:
setting the three-dimensional coordinate system according to the moving direction of the target at the first moment.

17. The control method of claim 16, wherein setting the three-dimensional coordinate includes setting the position of the target at the first moment as an origin of the three-dimensional coordinate system.

18. The control method of claim 16, wherein setting the three-dimensional coordinate includes setting an axis of the three-dimensional coordinate system to be along the moving direction of the target.

19. The control method of claim 18,
wherein the axis is a first axis of the three-dimensional coordinate system;
the method further comprising:
determining that the target is a vehicle according to an image shot by the imaging apparatus; and
determining that the target does not move along a second axis of the three-dimensional coordinate system perpendicular to the moving direction of the target.

20. The control method of claim 18,
wherein the axis is a first axis of the three-dimensional coordinate system;
the method further comprising:
determining that the target is a vehicle traveling on a straight road according to an image shot by the imaging apparatus; and
determining that the target does not move along a second axis of the three-dimensional coordinate system perpendicular to the moving direction of the target, and does not move along a third axis of the three-dimensional coordinate system perpendicular to the moving direction of the target and the second axis.
